(19) United States
(12) Patent Application Publication
(10) Pub. No.: US 2009/0300103 A1
(43) Pub. Date: Dec. 3, 2009

(54) STORAGE MEDIUM RECORDING A PROGRAM FOR REWRITING UNIFORM RESOURCE LOCATOR INFORMATION

(75) Inventor: Takahide MATSUTSUKA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/361,998

(22) Filed: Jan. 29, 2009

(30) Foreign Application Priority Data
May 30, 2008 (JP) 2008-143723

(51) Int. Cl. G06F 15/16

(52) U.S. Cl. 709/203

(57) ABSTRACT

A client terminal receives the page information of an original server and a rewriting program from a relay server and rewrites the page information by executing the rewriting program. Then, the client terminal creates a request to the original server on the basis of the description of the page information and changes the server name of the original server in URL information included in the request to the server name of the relay server according to the rewriting information of the page information. Then, the client terminal transmits the request to the relay server according to changed uniform resource locator information.

### CROSS-REFERENCE TO RELATED APPLICATIONS

This application is based upon and claims the benefit of priority of the prior Japanese Patent Application No. 2008-143723, filed on May 30, 2008, the entire contents of which are incorporated herein by reference.

### FIELD

The embodiments discussed herein are related to a storage medium on which a program for rewriting uniform resource locator (URL) information included in Web pages.

### BACKGROUND

When a client terminal accesses a web page in a Web server, a relay server, such as a translation server, a portal server and the like are used for a server for relaying communications between the client terminal and the Web server. A translation server, for example, accesses Web servers distributing an English Web page, translates the English of the received Web page into Japanese and transmits it to the client terminal. A portal server, for example, pastes a Web page, such as a map and the like distributed by the Web server on its own Web page and transmits it to the client terminal.

In such a relay system, when a user clicks a link and the like in a Web page displayed on the screen of a client terminal, the Web server is accessed via the relay server again. For example, when a link or the like in a page translated by the translation server is clicked, in order to display the translated page of its link destination too, the Web server is accessed via the relay server.

Then, when transmitting hypertext markup language (HTML) document received from the original Web server to the client terminal, the relay server rewrites the URL in the HTML document.

FIG. 26 illustrates such a conventional method of rewriting an URL. The reading unit 32 of a relay server 12 reads Web page 22 from an original server 13. An analysis unit 34 analyzes the Web page 22. A rewriting unit 33 rewrites an URL in the Web page 22. In this rewriting unit 33, portions describing a transmitting operation to a server, such as an “a” tag, a “form” tag and the like, in the HTML document are rewritten. A transmitting unit 31 transmits the rewritten Web page 21 to a client terminal 11.

A system in which a client terminal changes a URL of an access destination is known. A system in which a relay server selects a request in a request history and reproduces a path is also known.

Patent document 1 Japanese Laid-open Patent Publication No. 2002-032273

Patent document 2: Japanese Translation Publication No. 2003-530625 of PCT International Patent Application

### SUMMARY

According to an aspect of the invention, a program transmitted together with page information of an original server to a client computer from a relay server for transferring the page information to the client computer is recorded on a storage medium. The program enables the client computer to perform rewriting the page information in such a way that a server name of the original server in uniform resource locator information included in a request to the original server is changed to a server name of the relay server when the client computer transmits the request on the basis of the description of the page information.

According to another aspect of the invention, a request transmitting method includes receiving page information of an original server and a rewriting program from a relay server, rewriting the page information in such a way that a server name of the original server in uniform resource locator information is changed to a server name of the relay server, by executing the rewriting program, creating a request to the original server on the basis of the description of the page information, changing the server name of the original server in the uniform resource locator information included in the request to the server name of the relay server, and transmitting the request to the relay server according to changed uniform resource locator information.

According to a further aspect of the invention, an information processing apparatus includes a receiving device, a rewriting device, a changing device and a transmitting device. The receiving device receives page information of an original server and a rewriting program from a relay server. The rewriting device rewrites the page information in such a way that a server name of the original server in uniform resource locator information is changed to a server name of the relay server, by executing the rewriting program. The changing device changes the server name of the original server in uniform resource locator information included in a request to the original server when transmitting the request on the basis of the description of the page information. The transmitting device transmits the request to the relay server according to changed uniform resource locator information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates the configuration of an URL rewriting system;

FIG. 2 illustrates the basic operation of a browser;

FIG. 3 illustrates the first request transmitting operation;

FIG. 4 illustrates the second request transmitting operation

FIG. 5 illustrates the third request transmitting operation

FIG. 6 illustrates the fourth request transmitting operation;

FIG. 7 illustrates a Web page;

FIG. 8 illustrates a rewriting script;

FIG. 9 is the flowchart of an initialization process;

FIG. 10 is the flowchart of a form rewriting process;

FIG. 11 is the flowchart of a submit button rewriting process;

FIG. 12 is the flowchart of “a” tag rewriting process;

FIG. 13 is the flowchart of an XMLHttpRequest rewriting process;

FIG. 14 is the flowchart of a DOM API rewriting process;

FIG. 15 is the flowchart of a DOM event registration process;

FIG. 16 is the flowchart of a setInterval registration process;

FIG. 17 is the flowchart of the first transmitting process;

FIG. 18 is the flowchart of the second transmitting process;

FIG. 19 is the flowchart of the third transmitting process;

FIG. 20 is the flowchart of the first object rewriting process;

FIG. 21 is the flowchart of individual element process;

FIG. 22 is the flowchart of the second object rewriting process;

FIG. 23 is the flowchart of a monitor process;

FIG. 24 illustrates the configuration of an information processing apparatus;

FIG. 25 illustrates how to provide a program and data; and

FIG. 26 illustrates the conventional URL rewriting method.

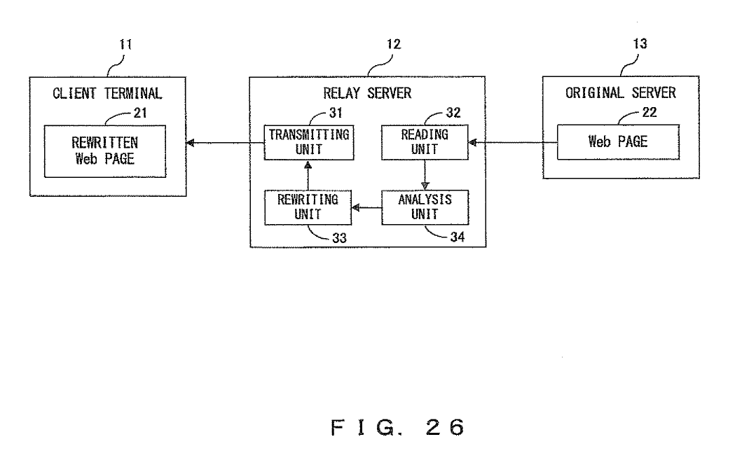

### DESCRIPTION OF EMBODIMENTS

The above-described conventional relay system has the following problems.
(1) Since URL is rewritten by a relay server, the resource of the relay server is consumed.
(2) When a client terminal dynamically creates URL by JavaScript (trademark) or the like, it is difficult to rewrite the URL.
(3) In the case of asynchronous communications, since URL is dynamically created by the program of JavaScript (trademark) or the like, it is difficult to rewrite the URL.

The preferred embodiments of the present invention will be explained below with reference to accompanying drawings.

In the URL rewriting system of the preferred embodiment, the server name of URL included in a request to a Web server is rewritten into the server name of a relay server by a client terminal instead of the relay server. Therefore, the relay server attaches a rewriting program (rewriting script) provided with a function to rewrite URL and transmits it to the client terminal.

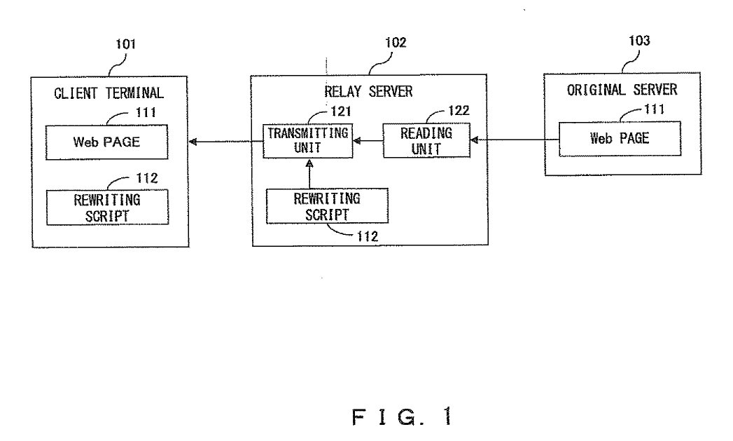

FIG. 1 illustrates the configuration example of such an URL rewriting system. The reading unit 122 of a relay server 102 reads a Web page 111 from an original server 103. The Web page 111 sometimes includes JavaScript (trademark). A transmitting unit 121 embeds a tag for instructing a rewriting script 112 as an additional reading tag or the script itself to the original page, and transmits the Web page 111 together with the rewriting script 112 to a client terminal 101.

The browser of the client terminal 101 displays the Web page 111 on a screen. In this case, the browser has or reads the rewriting script 112 The rewriting script 112 operates on the browser and rewrites a portion where the process of transmitting a request from the browser to a server is described in the HTML document of the Web page 111. Thus, the server name of the transmitting destination URL of a subsequent request is modified to the server name of the relay server 102.

Since the relay server 102 simply attaches the reading instruction of the rewriting script 112 to the Web page 111 and transmits it, the process is completed in a very short time, compared with rewriting the entire Web page 111.

Basically, since the rewriting is performed at the time of loading HTML document, JavaScript (trademark) for rewriting is included in either of the following scripts.

```
window.onload = funcion( ) { ... }
or
function rewrite( ) { ... }
if (typeof window.addEventListener == ‘function’) {
  window.addEventListener(‘load’, rewriter, false);
} else if (typeof window.attachEvent == ‘object’) {
  window.attachEvent(‘onload’, rewrite);
}
```

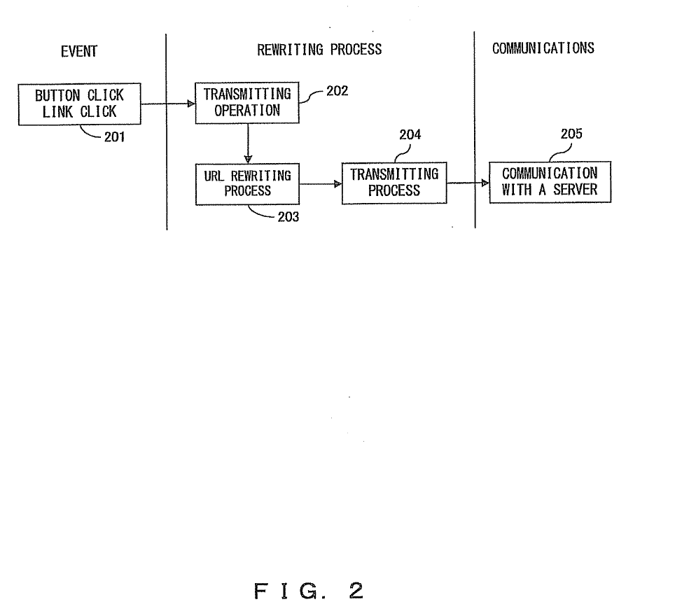

FIG. 2 illustrates the basic operation of a browser in there written Web page 111. When a user operation or the operation of the Web page 111, which causes a request to a server, is performed (typically a button or a link is clicked) (step 201), the browser performs a transmitting operation corresponding to a created event (step 202). In this case, after performing an URL rewriting process according to the description of the HTML document (step 203), the browser performs the original transmitting process (step 204). Then, the browser transmits a request to the relay server 102 (step 205).

For example, it is assumed that the URL of the relay server 102 and the URL of the Web page of the original server 103 being a request destination are as follows.

Relay server http://www.mycompany.com/ Web page http://www.othercmpany.com/ap/page.html

In this case, the URL of the Web page is, for example, rewritten as follows.

### EXAMPLE 1

http://www.mycompany.com/?http://www.othercompany.com/ap/pa ge.html

### EXAMPLE 2

http://www.othercompany.com.www.mycompany.com/ap/page.html In Example 1, “?” is inserted after the URL of the relay server 102 and the URL of the Web page is connected. In Example 2, the server name “www.othercompany.com” of the original server 103 is inserted before the server name “www.mycompany.com” of the relay server 102 and the path name of the Web page is connected after “www.mycompany.com/”.

The rewriting pattern of HTML document is classified as follows according to rewriting target.

### (1) Form

In the case of a form, the timing of request transmission is classified into the following two types.

(a) In the case of a request by a form.submit( ) function being JavaScript (trademark) application program interface (API) in a form, the submit function of a form is called. Then, the submit function is rewritten in such a way that a request destination URL in the submit function is changed.

(b) In the case of a request by a button specified by <input type=“submit”> in a form, the submit function of a form is not called. Therefore, a click listener (click event handler) is added to this button and the operation of the button at the time of submit is rewritten in such a way the submit function of a form is called in it. Then, as in the above (a), the sumbit function is rewritten.

(2) Anchor (“a” tag)

As to submit operation by “a” tag described as <a href=“ . . . ”>, its href element is rewritten and its operation at the time of “a” tag click is rewritten in such a way that a request destination URL is changed.

### (3) Image, Style and Script

In the case of an image, a style or a script, a request destination URL is changed by directly rewriting the src attribute of a corresponding img tag, the href attribute of a link tag or the src attribute of a script tag. For example, a case where the following tag is described is considered.

<img src=“images/myimg.jpg”>
<link type=“stylesheet” href=“css/mypage.css”>
<script src=“scripts/mylib.js”>

These tags are rewritten as follows.

<img src=“http://www.mycompany.com/?images/myimg.jpg”>
<link type=“stylesheet” href=“http://www.mycompany.com/?css/
mypage.css”>
<script src=“http://www.mycompany.com/?scripts/mylib.js”>

### (4) Asynchronous Communications

When an XMLHttpRequest object is used in asynchronous communications, the definition of the object itself is rewritten in such a way that a request destination URL is changed at the time of transmission. The URL of the XMLHttpRequest object is specified as follows by an open function.

var con=new XMLHttpRequest( );

con.open(“GET”, “search”, true);

Therefore, the second argument of the open function is rewritten into a URL via the relay server 102 in such a way that a request destination URL is changed at the time of calling the open function.

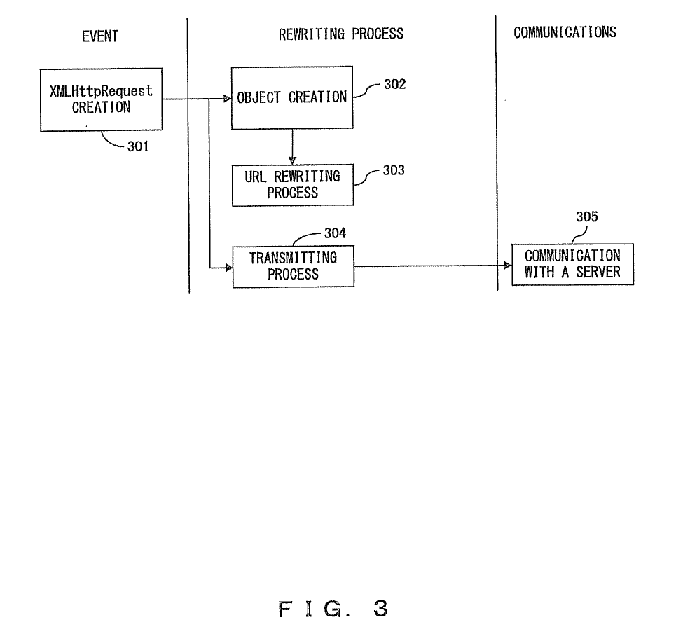

FIG. 3 illustrates a request transmitting operation by an XMLHttpRequest object. When an XMLHttpRequest is created by a user operation or an operation of the Web page 111 (step 301), a browser creates an XMLHttpRequest object (step 302). In this case, after performing an URL rewriting process according to the open function after rewriting (step 303), the browser performs a transmitting Process (step 304). Then, the browser transmits a request to the relay server 102 (step 305).

### (5) Rewriting by a Document Object Model (DOM) API

When the Web page 111 includes JavaScript (trademark) and an element is dynamically created in the Web page 111, a generation function is rewritten. Thus, a request destination URL is changed at the time of request transmission by the created element. The DOM API creates an element as follows.

var anchor document.createElement(“a”);

anchor.href=“mypage.htmll”;

When a form, an anchor, an image, a stylesheet or a script is created by rewriting this createElement function, the operation in the case where a request is transmitted by the element can be changed.

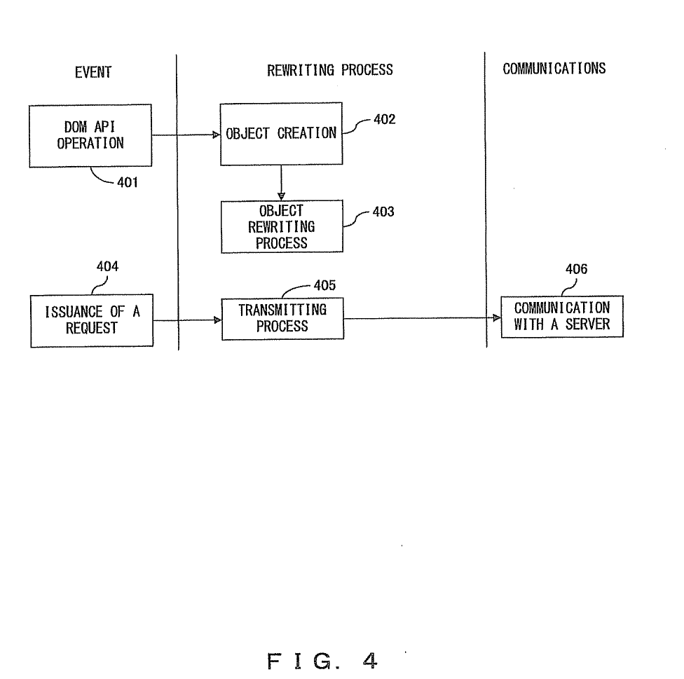

FIG. 4 illustrates a request transmitting operation based on a DOM API. When a DOM API is operated by a user operation or the operation of the Web page 111 (step 401), a browser creates an object (element) by a createElement function (step 402). In this case, the browser performs an object rewriting process according to the createElement function after rewriting (step 403)

Then, when a request is issued by the user operation or the operation of the Web page 111 (step 404), the browser rewrites an URL according to the object after rewriting and performs a transmitting process (step 405). Then, the browser transmits the request to the relay server 102 (step 406).

(6) document.write syntax or innerHTML syntax

When the Web page 111 includes JavaScript (trademark) and the Web page 111 is changed by document.write or innerHTML, what a character string to be specified includes is unknown. Therefore, it is difficult to perform a process in which an element to be created is predicted as in the case of the createElement function. There are the following two types of countermeasures in this case.

(a) When the Web page 111 is changed by document.write or innerHTML, a DOM change event occurs. Therefore, by catching this change event, a changed part can be obtained and a URL can be rewritten. For example, the following DOM event listener is added at the time of initialization. document.addEventListner(“MutationEvent”, rewrite, true);

Thus, a rewrite function can be called when the Web page 111 is changed and an object rewriting process can be performed by the rewrite function.

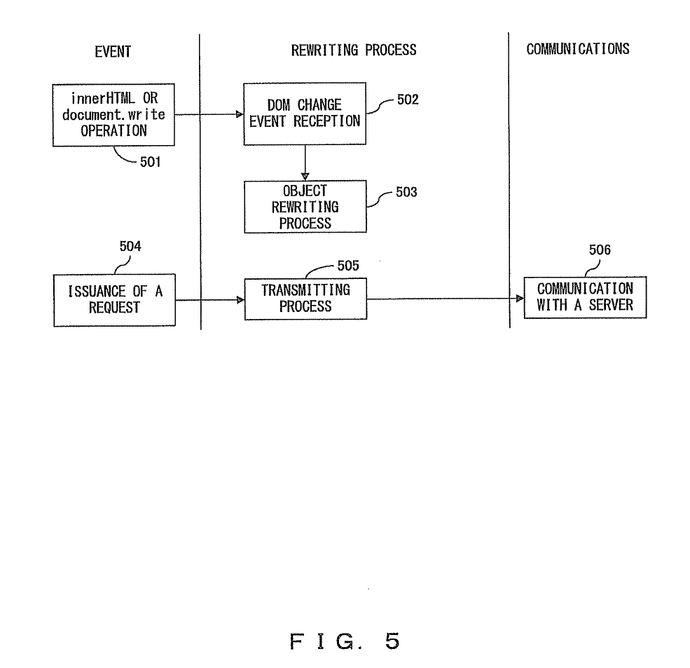

FIG. 5 illustrates a request transmitting operation based on the receipt of a DOM change event. When document.write or innerHTML operates by a user operation or the operation of the Web page 111 (step 501), a browser receives a DOM change event by the DOM event listener (step 502). At this time, the browser performs an object rewriting process according to a rewrite function or the like (step 503).

Then, when a request is issued by the user operation or the operation of the Web page 111 (step 504), the browser rewrites an URL according to the object after rewriting and performs a transmitting process (step 505). Then, the browser transmits the request to the relay server 102 (step 506).

(b) When a DOM event is not supported as seen in some browsers, a change event is monitored using a regular monitor function, such as a setInterval. For example, the following setInterval is added at the time of initialization. setInterval(check, 100);

Thus, a check function is called every 100 milli-second and it is checked whether the Web page 111 has been changed. If the Web page 111 has been changed, the changed part is analyzed and an object rewriting process is performed, if necessary.

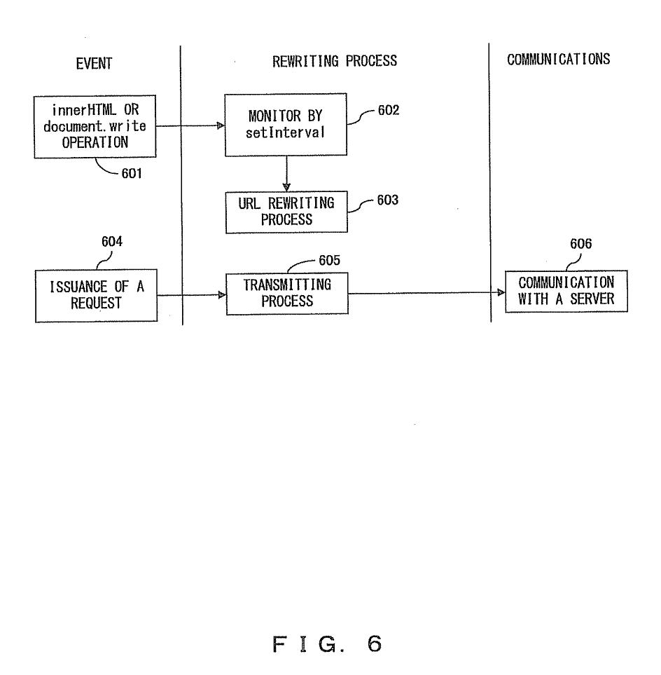

FIG. 6 illustrates a request transmitting operation based on the monitor operation. When document.write or innerHTML operates by a user operation or the operation of the Web page 111 (step 601), a browser detects a change event by a check function (step 602) In this case, the browser performs an object rewriting process, if necessary (step 603).

When a request is issued by the user operation or the operation of the Web page 111 (step 604), the browser rewrites an URL according to the object after rewriting and performs a transmitting process (step 605). Then, the browser transmits the request to the relay server 102 (step 606).

By describing the rewriting patterns of the above-described (1) through (6) in the rewriting script 112, a URL can be changed in such a way that a request from the client terminal 101 may be transmitted via the relay server 102 in any situation. It is also possible to use a rewriting script 112 including only a part of the rewriting patterns (1) through (6).

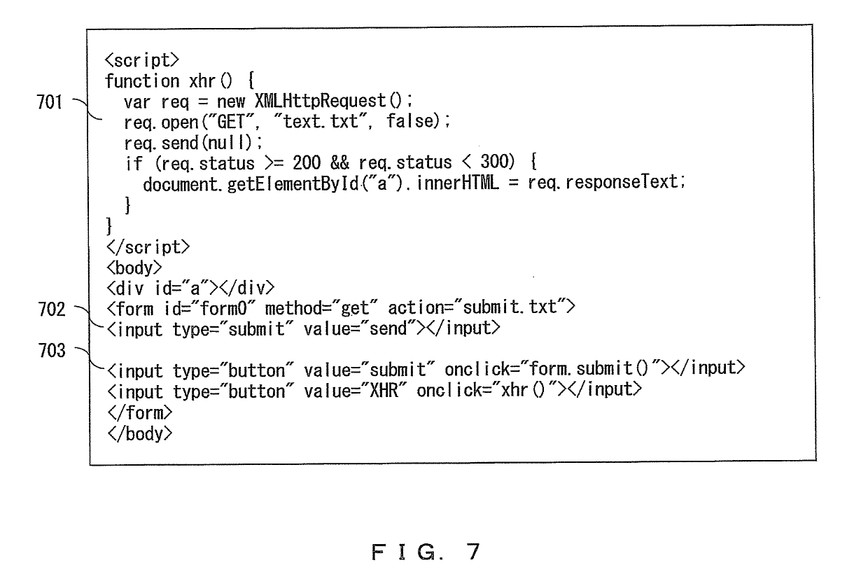

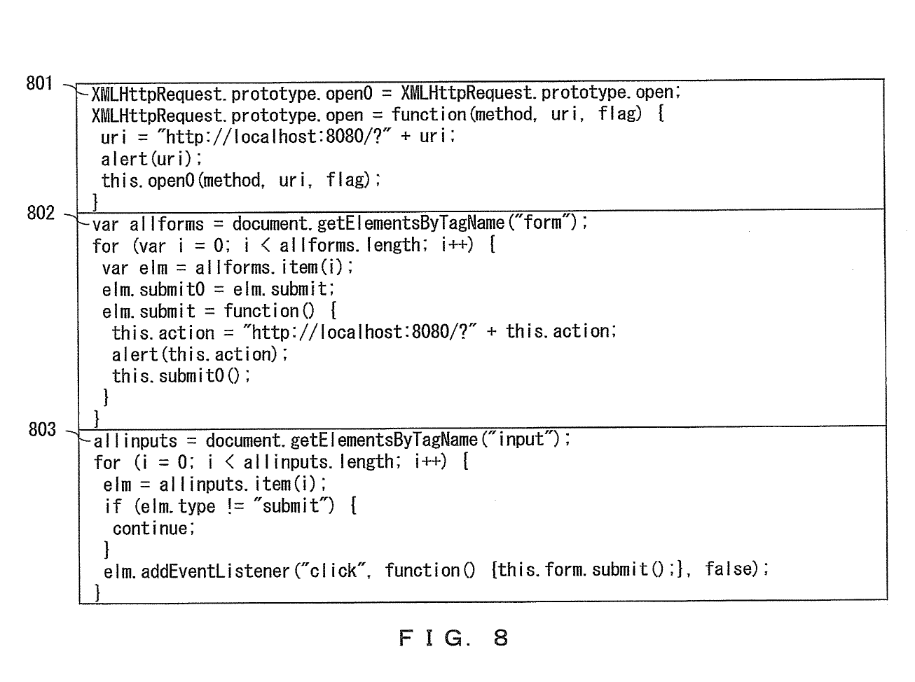

FIG. 7 illustrates an example of the Web page 111. FIG. 8 illustrates an example of the rewriting script 112. In the rewriting script illustrated in FIG. 8, “http://localhost:8080/” is used for the URL of the relay server 102. The script part 801 of this rewriting script 112 rewrites an asynchronous communication request 701. The script part 802 rewrites the request 703 of a submit function in a form and the script part 803 rewrites the request 702 by a button in a form.

According to the URL rewriting system illustrated in FIG. 1 the following effects can be obtained.
(1) Since no URL rewriting process is necessary in a relay server, the load of the relay server can be drastically reduced.
(2) Even when a client terminal dynamically creates an URL, the URL can be rewritten.
(3) Even in the case of asynchronous communications, an URL can be rewritten.

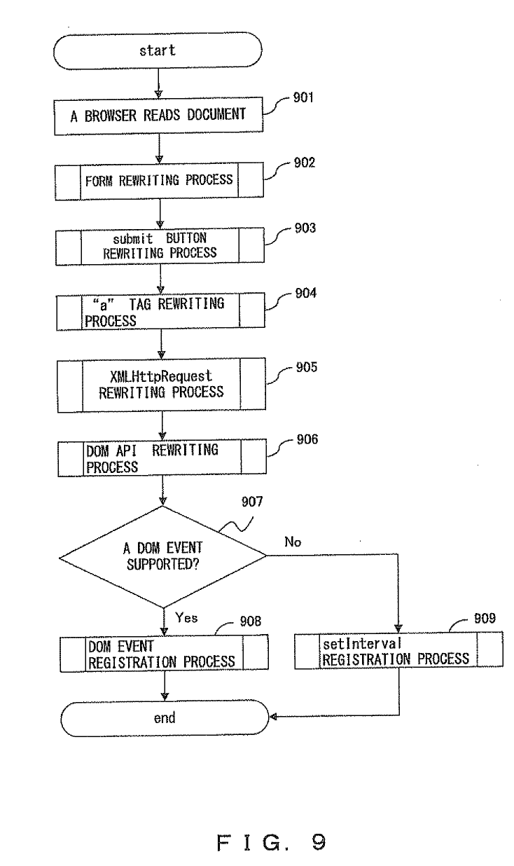

Next, the process of a browser in the case of using the rewriting script 112 including a plurality of rewriting patterns is described with reference to FIGS. 9 through 23.

FIG. 9 is the flowchart of an initialization process by a browser Firstly, a browser reads the HTML document of the Web page 111 and a rewriting script 112 that are received from the relay server 102 (step 901).

Then, according to the rewriting script 112, a form rewriting process (step 902), a submit button rewriting process (step 903), an “a” tag rewriting process (step 904) and an XMLHttpRequest rewriting process (step 905) and a DOM API rewriting process (step 906) are performed.

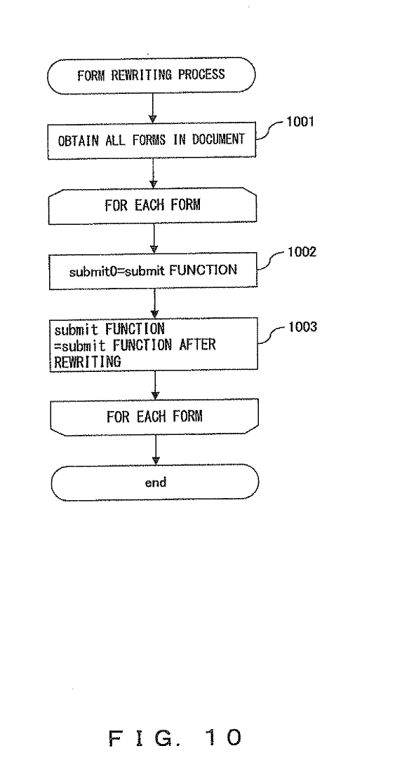

FIG. 10 is the flowchart of the form rewriting process in step 902 illustrated in FIG. 9. A browser obtains all forms in HTML document (step 1001). Then, the submit function of each form is stored as submit 0 (step 1002) and is replaced with the submit function after rewriting (step 1003). The submit function after rewriting has a function to change a request destination URL is to a URL via the relay server 102.

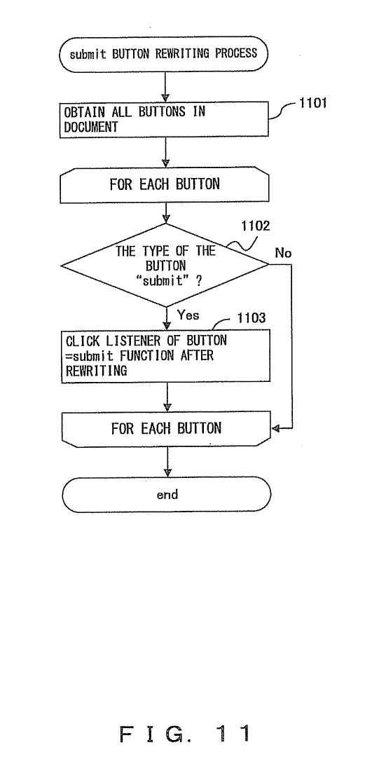

FIG. 11 is the flowchart of the submit button rewriting process in step 103 illustrated in FIG. 9. A browser obtains all buttons in HTML document (step 1101) and checks whether each button type is “submit” (step 1102). If the button type is “submit”, the submit function after rewriting is registered as the click listener of the button (step 1103).

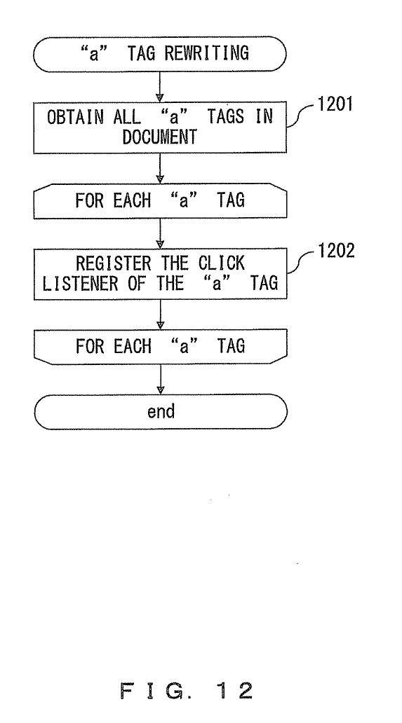

FIG. 12 is the flowchart of an “a” tag rewriting process in step 904 illustrated in FIG. 9. A browser obtains all “a” tags in HTML document (step 1201) and registers the click listener of each “a” tag (step 1202). The click listener of the “a” tag has a function to change a request destination URL to a URL via the relay server 102.

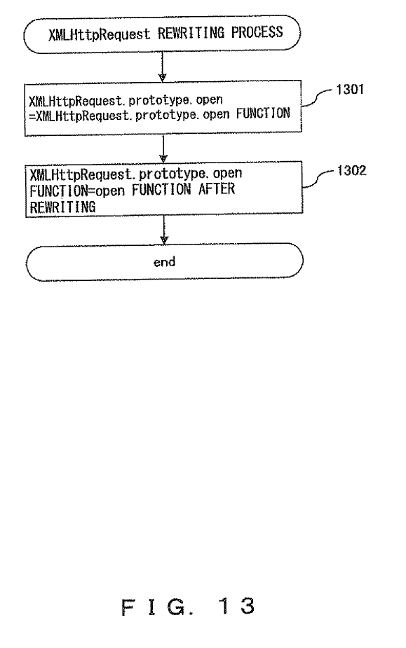

FIG. 13 is the flowchart of the XMLHttpRequest rewriting process in step 905 illustrated in FIG. 9. A browser stores an XMLHttpRequest.prototype.open function in HTML document as XMLHttpRequest.prototype.open0 (step 1301). Then,the XMLHttpRequest.prototype.open function is replaced with an open function after rewriting (step 1302). The open function after rewriting has a function to change a request destination URL to a URL via the relay server 102.

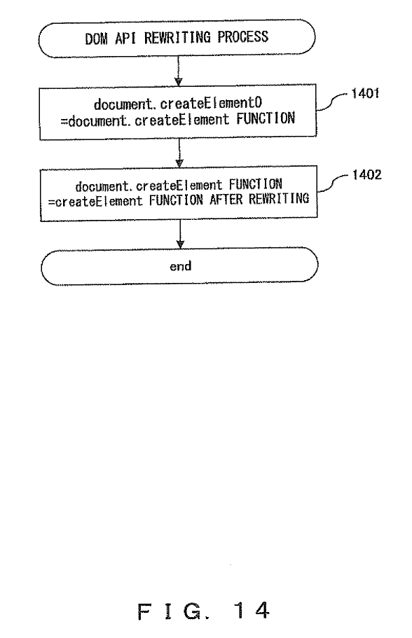

FIG. 14 is the flowchart of the DOM API rewriting process in step 906 illustrated in FIG. 9. A browser stores a document.createElement function as document.createElement0 (step 1401). Then, the document.createElement function is replaced with a createElement function after rewriting (step 1402). The document.createElement function has a function to rewrite a created element in order to change a request destination URL.

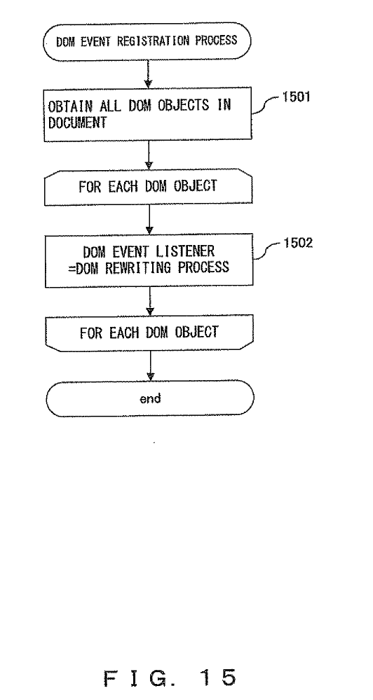

FIG. 15 is the flowchart of the DOM event registration process in step 908 illustrated in FIG. 9. A browser obtains all DOM objects in HTML document (step 1501) and registers a DOM rewriting process as the DOM event listener of each DOM object (step 1502), the DOM event listener has a function to rewrite a created element in order to change a request destination URL.

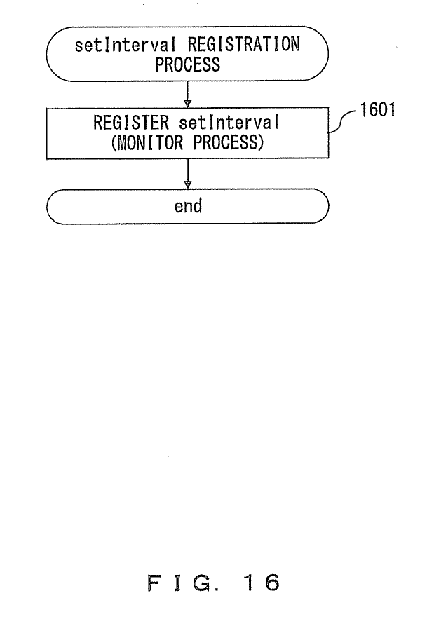

FIG. 16 is the flowchart of the setInterval registration process in step 909 illustrated in FIG. 9. A browser registers setInterval as a monitor process (step 1601). The registered setInterval monitors a change event.

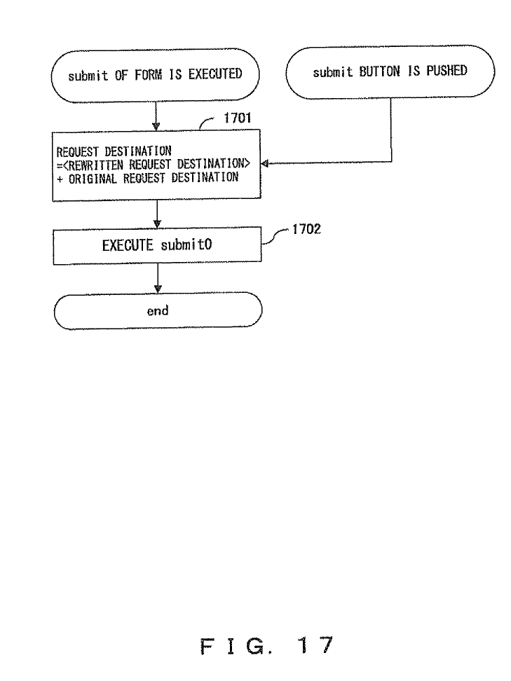

FIGS. 17 through 23 illustrate the request transmitting process and object rewriting process in the case where an event is created by a user operation or the operation of the Web page 111 after completion of an initialization process.

FIG. 17 is the flowchart of the transmitting process performed when the submit of a form is executed or when a submit button is clicked. Firstly, a browser calls an after-rewriting submit function stored as a submit function and modifies a request destination URL to a URL via the relay server 102 (step 1701. Then, the browser executes the stored submit0 (original submit function) (step 1702). Thus, a request is transmitted to the relay server 102.

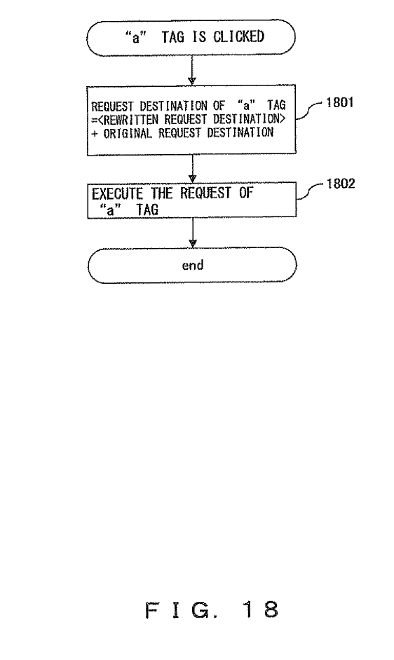

FIG. 18 is the flowchart of the transmitting process performed when an “a” tag is clicked. Firstly, a browser changes a request destination URL to a URL via the relay server 102 using an “a” tag click listener (step 1801). Then, the browser executes the request of an “a” tag (step 1802). Thus, the request is transmitted to the relay server 102.

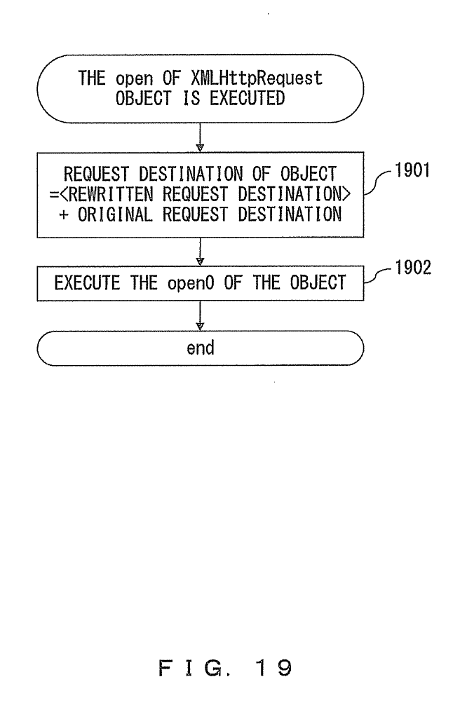

FIG. 19 is the flowchart of the transmitting process performed when the open of an XMLHttpRequest object is executed. Firstly, a browser calls an after-rewriting open function stored as an XMLHttpRequest.prototype.open function and changes a request destination URL to a URL via the relay server 102 (step 1901). Then, the browser executes the stored open0 (original submit function) (step 1902). Thus, a request is transmitted to the relay server 102.

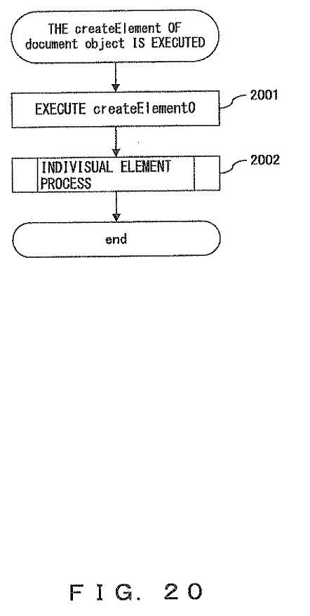

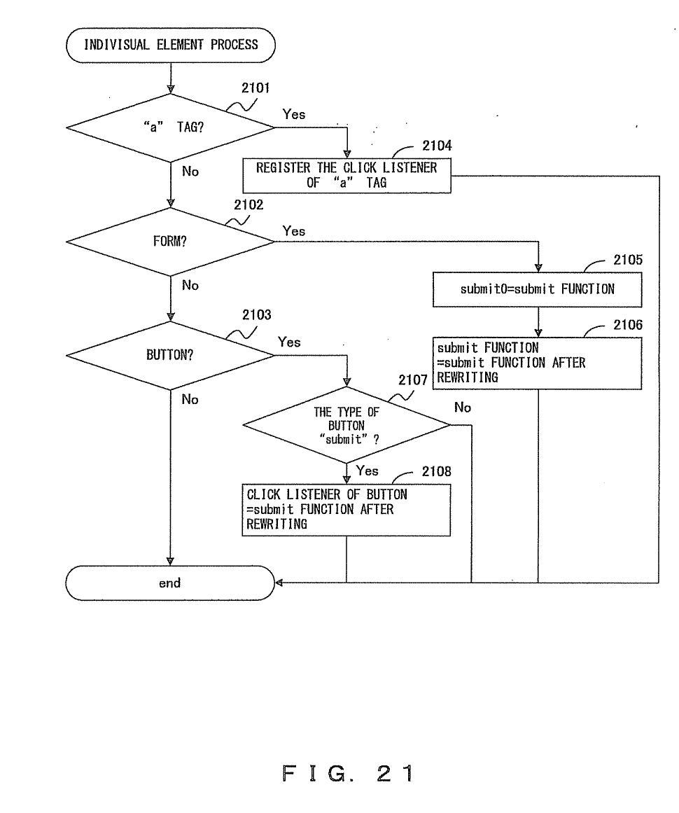

FIG. 20 is the flowchart of the object rewriting process performed when the createElement function of a document object is executed. Firstly, a browser executes createElement0 (original createElement function) and creates a new element (step 2001). Then, the browser performs the individual element process illustrated in FIG. 21 (step 2002).

In the individual element process, firstly, a browser checks whether a created element is an “a” tag. If the element is an “a” tag, the browser registers the click listener of the “a” tag (step 2104).

If the element is not an “a” tag, then it is checked whether the element is a form (step 2102). If the created element is a form, the browser stores the submit function of the form as submit0 (step 2105) and replaces the submit function of the form with an after-rewriting submit function (step 2106).

If the generated element is not a form, then it is checked whether the element is a button (step 2103). If the created element is a button, it is checked whether the type of the button is “submit” (step 2107). Then, if the type of the button is “submit”, the browser registers an after-rewriting submit function as the click listener of the button (step 2108).

According to such an individual element process, a change, such as the addition of a click listener, the rewriting of a submit function or the like is performed according to the type of a created element. Then, when an event occurs on the basis of the element, a request is transmitted to the relay server 102.

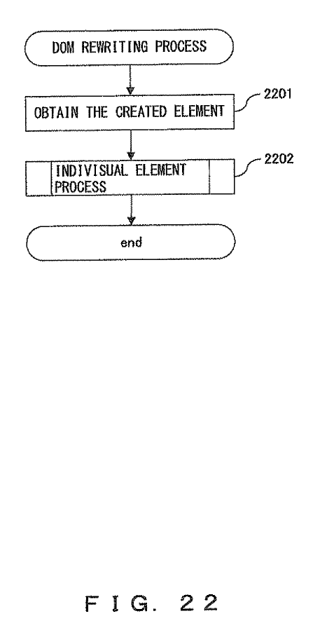

FIG. 22 is the flowchart of the object rewriting process performed when the Web page 111 is changed by document.write or innerHTML and a DOM change event occurs. Firstly, a browser executes a DON rewriting process stored as a DON event listener and obtains a new created element (step 2201). Then, the browser performs the individual element process illustrated in FIG. 21 (step 2202).

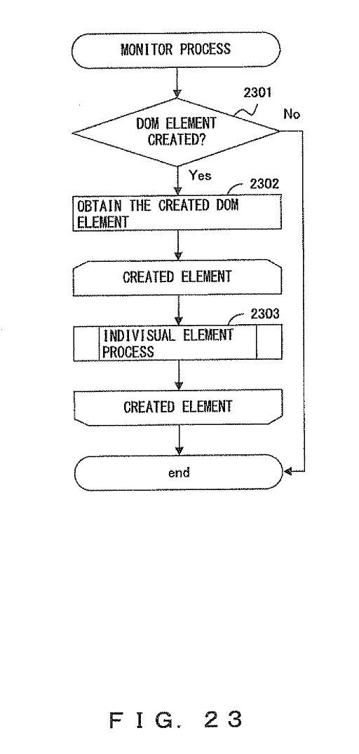

FIG. 23 is the flowchart of the monitor process registered in step 1601 illustrated in FIG. 21. Firstly, a browser checks whether a DOM element is created by a change event, using a check function (step 2301). If a DOM element is created, the browser obtains the created DOM element (step 2302) and applies the individual element process illustrated in FIG. 21 to each DOM element (step 2303).

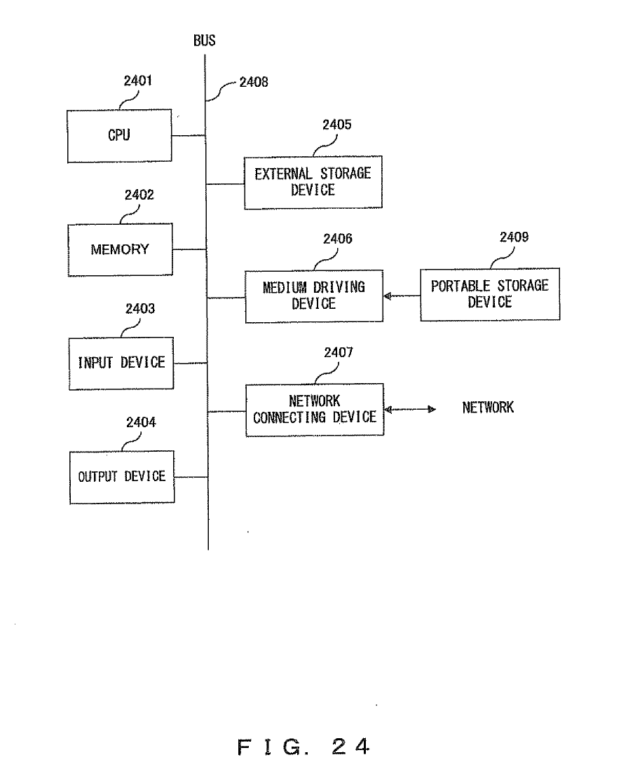

The client terminal 101, relay server 102 and original server 103 illustrated in FIG. 1 can be configured using, for example, the information processing apparatus (computer) illustrated in FIG. 24. The information processing apparatus illustrated in FIG. 24 comprises a CPU 2401, memory 2402, an input device 2403, an output device 2404, an external storage device 2405, a medium driving device 2406 and a network connecting device 2407, which are connected to each other by a bus 2408.

The memory 2402 includes, for example, a read-only memory (ROM), a random-access memory (RAM) and the like, and stores a program and data that are used for the process. The program stored in the memory 2402 includes a browser and a rewriting script 112. The data stored in the memory 2402 includes the HTML document of the Web page 111. The CPU 2401 performs the process of the client terminal 101, relay server 102 or original server 103 by executing the program using the memory 2402.

The input device 2403 includes a keyboard, a pointing device and the like and is used to input instructions and information from an operator or a user. The output device 2404 includes a display, a printer, a speaker and the like and is used to output inquiries and process results to the operator or the user.

The external storage device 2405 includes a magnetic disk device, an optical disk device, a magneto-optical disk device, a tape device, a solid state disk device and the like. The information processing apparatus stores the program and data in this external storage device 2405 in advance, and loads them onto the memory 2402 to user if requested.

The medium driving device 2406 drives a portable storage medium 2409 to access its recorded contents. The portable storage medium 2409 is an arbitrary computer-readable storage medium, such as a memory card, a flexible disk, an optical disk, a magneto-optical disk or the like. The operator or user stores the program and data in this portable storage medium 2409 in advance and loads them onto the memory 2402 to use, if requested.

The network connecting device 2407 is connected to a communication network, such as the Internet or the like, and performs data conversion necessary for communications. The information processing apparatus also receives the program and data from an external device via the network connecting device 2407 and loads them onto the memory 2402 to use, if requested.

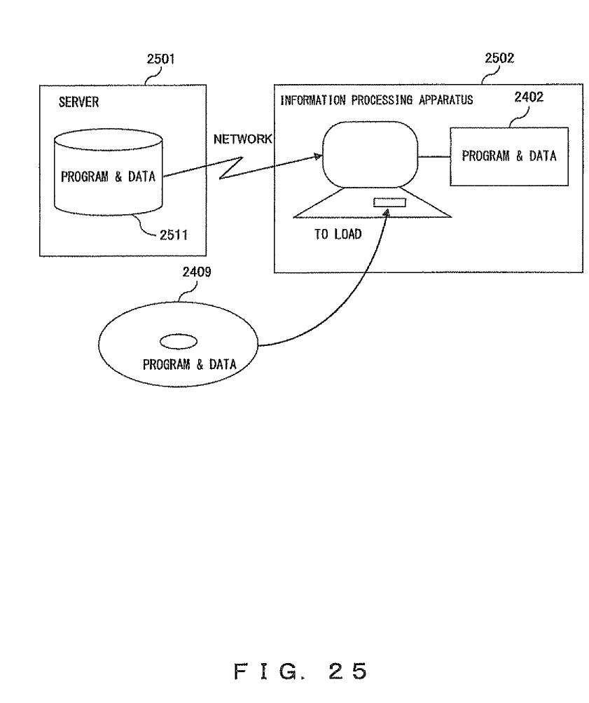

FIG. 25 illustrates how to provide a program and data to the information processing apparatus illustrated in FIG. 24. The program and data stored in the portable storage medium 2409 or the database 2511 of an external device 2501 is loaded onto the memory 2402 of the information processing apparatus 2502. The external device 2501 creates a carrier signal for carrying the program and data and transmits them to the information processing apparatus 2502 via an arbitrary transmission medium on a communication network. The CPU 2401 executes the program using the data to perform the above-described process.

As described above, according to the disclosed system, a URL is rewritten when a client terminal transmits a request to an original server instead of the relay server rewriting a URL. Therefore, even when a request is dynamically created or even when asynchronous communications are conducted, the URL of the original server can be rewritten to a URL via the relay server.

All examples and conditional language recited herein are intended for pedagogical purposes to aid the reader in understanding the principles of the invention and the concept contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A storage medium on which is recorded a program that is transmitted together with page information of an original server to a client computer from a relay server for transferring the page information to the client computer, the program enabling the client computer to perform:
rewriting the page information in such a way that a server name of the original server in uniform resource locator information included in a request to the original server is changed to a server name of the relay server when the client computer transmits the request on the basis of a description of the page information.

2. The storage medium according to claim 1, the program further enabling the client computer to perform:
adding rewriting information for changing the server name of the original server in the uniform resource locator information included in the request to the server name of the relay server, to the page information when the client computer creates new element information for creating the request on the basis of the description of the page information.

3. The storage medium according to claim 2, wherein
when the new element information is an “a” tag, the client computer adds rewriting information for changing the server name of the original server in the uniform resource locator information included in the request created when the “a” tag is clicked, to the page information, when the new element information is a form, the client computer adds rewriting information for changing the server name of the original server in the uniform resource locator information included in the request created when a submit function of the form is executed, to the page information and when the new element information is a submit button, the client computer adds rewriting information for changing the server name of the original server in the uniform resource locator information included in the request created when the submit button is clicked, to the page information.

4. The storage medium according to claim 1, wherein
the client computer changes the server name of the original server in the uniform resource locator information included in the request created when a submit function of a form included in the page information is executed or when a submit button of the form is clicked, to the server name of the relay server.

5. The storage medium according to claim 1, wherein
the client computer changes the server name of the original server in the uniform resource locator information included in the request created when an “a” tag included in the page information is clicked, to the server name of the relay server.

6. The storage medium according to claim 1, wherein
the client computer changes the server name of the original server in the uniform resource locator information described in an src attribute of an img tag, an href attribute of a link tag or an src attribute of a script tag included in the page information, to the server name of the relay server.

7. The storage medium according to claim 1, wherein
the client computer changes the server name of the original server in the uniform resource locator information included in the request created when an open function of an XMLHttpRequest object included in the page information is executed, to the server name of the relay server.

8. A request transmitting method, comprising:
receiving page information of an original server and a rewriting program from a relay server;
rewriting the page information in such a way that a server name of the original server in uniform resource locator information is changed to a server name of the relay server, by executing the rewriting program;
creating a request to the original server on the basis of a description of the page information;
changing the server name of the original server in uniform resource locator information included in the request to the server name of the relay server; and
transmitting the request to the relay server according to changed uniform resource locator information.

9. An information processing apparatus, comprising:
a receiving device for receiving page information of an original server and a rewriting program from a relay server;
a rewriting device for rewriting the page information in such a way that a server name of the original server in uniform resource locator information is changed to a server name of the relay server, by executing the rewriting program;
a changing device for changing the server name of the original server in uniform resource locator information included in a request to the original server to the server name of the relay server when transmitting the request on the basis of a description of the page information; and
a transmitting device for transmitting the request to the relay server according to changed uniform resource locator information.
